(19) United States
(12) Patent Application Publication
(10) Pub. No.: US 2012/0249487 A1
(43) Pub. Date: Oct. 4, 2012

(54) METHOD OF IDENTIFYING A MULTI-TOUCH SHIFTING GESTURE AND DEVICE USING THE SAME

(75) Inventors: Tiejun Cai, Shenzhen (CN); Lianfang Yi, Shenzhen (CN); Guilan Chen, Shenzhen (CN); Bangjun He, Shenzhen (CN); Yun Yang, Shenzhen (CN)

(73) Assignee: BYD COMPANY LIMITED, Shenzhen (CN)

(21) Appl. No.: 13/409,060

(22) Filed: Feb. 29, 2012

(30) Foreign Application Priority Data
Mar. 31, 2011 (CN) 201110081252.8

(51) Int. Cl. G06F 3/043; G06F 3/041

(52) U.S. Cl. 345/177; 345/173

(57) ABSTRACT

A method of identifying a shifting gesture comprises detecting one or more induction signals induced by one or more pointing objects that come into contact with a touch-sensitive surface, determining the number of the pointing objects that come into contact with the touch-sensitive surface, recording moving status and coordinates of each pointing object in an instance in which the number of the pointing objects is larger than a preset number, determining whether one pointing object moves in a direction parallel to the direction that another pointing object moves in according to the recorded moving status and the coordinates of the pointing objects and generating control signals to execute a gesture associated with the determined result.

### CROSS-REFERENCE TO RELATED APPLICATION

This application claims priority under 35 U.S.C. §119 to Chinese Patent Application No. 201110081252.8, filed on Mar. 31, 2011, the content of which is incorporated herein by reference in its entirety.

### TECHNICAL FIELD

Example embodiments of the present disclosure relate generally to a method of identifying gestures on a touchpad, and more particularly, to a method of identifying a shifting gesture and device thereof.

### BACKGROUND

Although the keyboard remains a primary input device of a computer, the prevalence of graphical user interfaces (GUIs) may require use of a mouse or other pointing device such as a trackball, joystick, touch device or the like. Due to its compact size, the touch device has become popular and widely used in various areas of our daily lives, such as mobile phones, media players, navigation systems, digital cameras, digital cameras, digital photo frame, personal digital assistance (PDA), gaming devices, monitors, electrical control, medical equipment and so on.

A touch device features a sensing surface that can translate the motion and position of a user's fingers to a relative position on screen. Touchpads operate in one of several ways. The most common technology includes sensing the capacitive virtual ground effect of a finger, or the capacitance between sensors. For example, by independently measuring the self-capacitance of each X and Y axis electrode on a sensor, the determination of the (X, Y) location of a single touch is provided.

### SUMMARY

According to one exemplary embodiment of the present invention, a method of identifying a shifting gesture comprises detecting one or more induction signals induced by one or more pointing objects that come into contact with a touch-sensitive surface, determining the number of the pointing objects that come into contact with the touch-sensitive surface, recording moving status and coordinates of each pointing object in an instance in which the number of the pointing objects is larger than a preset number, determining whether one pointing object moves in a direction parallel to the direction that another pointing object moves according to the recorded moving status and the coordinates of the pointing objects; and generating control signals to execute a gesture associated with the determined result.

According to one exemplary embodiment of the present invention, a device of identifying multi-touch points comprises a detecting module, a determination module, a recording module and a processing module. The detecting module is configured to detect one or more induction signals induced by one or more pointing objects that come into contact with a touch-sensitive surface. The determination module is configured to determine the number of pointing objects. The recording module is configured to record moving status and coordinates of each pointing object if the number of the pointing objects is larger than a preset number. The processing module is configured to determine if one pointing object moves in a direction parallel to the direction that another pointing object moves according to the moving status and coordinates of each pointing object and generate control signals to execute a gesture associated with the determined result.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a block diagram of a device of identifying a shifting gesture according to one exemplary embodiment of the present invention;

FIG. 2 illustrates a schematic diagram of inductive lines on a touch pad according to one exemplary embodiment of the present invention;

FIG. 3 illustrates a block diagram of a determination module according to one exemplary embodiment of the present invention;

FIG. 4 illustrates a block diagram of a processing module according to one exemplary embodiment of the present invention;

FIG. 5 illustrates a method of identifying a shifting gesture according to one exemplary embodiment of the present invention;

FIG. 6 illustrates a method of identifying the number of pointing objects that contact the touch screen according to one exemplary embodiment of the present invention;

FIGS. 7-9 illustrate diagrams of a detected induction signal and a reference signal according to exemplary embodiments of the present invention;

FIG. 10 illustrates a method of identifying a shifting gesture according to one exemplary embodiment of the present invention;

FIG. 11 illustrates a schematic diagrams of shifting gesture according to one exemplary embodiment of the present invention;

FIG. 12 illustrates a method of triggering a preset function according to one exemplary embodiment of the present invention;

FIG. 13 is a diagram illustrating moving directions of the pointing objects according to exemplary embodiments of the present invention; and

FIGS. 14A-C illustrate moving statuses of the pointing objects on the touch-sensitive surface according to exemplary embodiments of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In this regard, although example embodiments may be described herein in the context of a touch screen or touch-screen panel, it should be understood that example embodiments are equally applicable to any of a number of different types of touch-sensitive surfaces, including those with and without an integral display (e.g., touchpad). Also, for example, references may be made herein to axes, directions and orientations including X-axis, Y-axis, vertical, horizontal and/or diagonal; it should be understood, however, that any direction and orientation references are simply examples and that any particular direction or orientation may depend on the particular object, and/or the orientation of the particular object, with which the direction or orientation reference is made. Like numbers refer to like elements throughout.

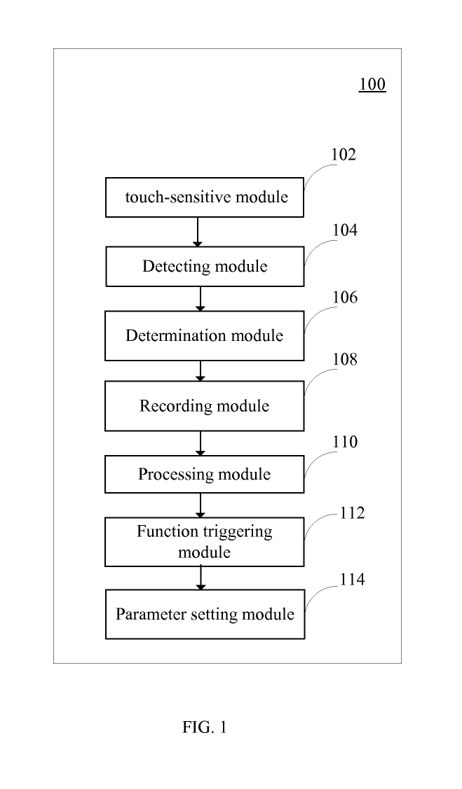

FIG. 1 illustrates a schematic diagram of a device of identifying a shifting gesture 100 according to an exemplary embodiment of the present invention (“exemplary” as used herein referring to “serving as an example, instance or illustration”). As explained below, the device of identifying a shifting gesture 100 may be configured to determine a shifting gesture based on movement status of each pointing object on a touch screen. The touch screen may be a resistive touch screen, a capacitive touch screen, an infrared touch screen, an optical imaging touch screen, an acoustic pulse touch screen, surface acoustic touch screen or in any other forms.

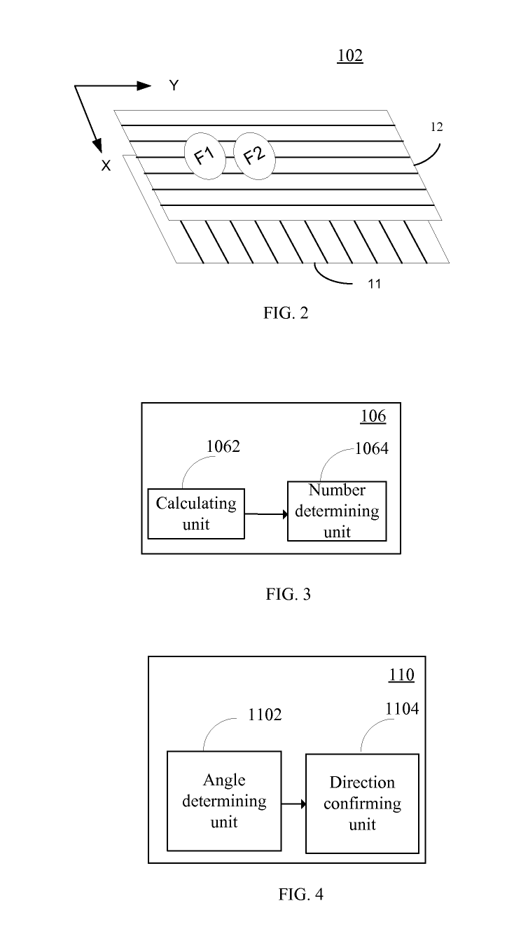

As illustrated in FIG. 1, the device of identifying a shifting gesture 100 may include a touch-sensitive module 102, a detecting module 104, a determination module 106, a recording module 108, and a processing module 110. In one embodiment, the device of identifying a shifting gesture 100 may further comprise a function triggering module 112 and a parameter setting module 114. The touch-sensitive module 102 of one example may be as illustrated in FIG. 2. The determination module 106 may include a calculating unit 1062 and a number determining unit 1064 as illustrated in FIG. 3. The processing module 110 may include an angle determining unit 1102, and a direction determining unit 1104 as illustrated in FIG. 4. The recording module 108 may record moving statuses of each pointing object. The processing module 110 may determine whether one pointing objection performs a moving operation in a direction parallel to the direction that another pointing object moves, according to the recorded moving status and may generate control signals and execute a shifting command in response to the generated control signals.

FIG. 2 illustrates a schematic diagram of a touch-sensitive surface according to one exemplary embodiment of the present invention. The touch-sensitive module 102 may include a plurality of inductive lines 11 and 12 on respective X and Y axes to form the touch-sensitive surface. In other exemplary embodiments, the touch-sensitive module 102 may comprise an acoustic sensor, optical sensor or other kind of sensor to form a touch-sensitive surface for sensing the touch by the pointing objects. The X and Y axes may be perpendicular to each other, or have a specific angle other than 90°. As also shown, F1 and F2 indicate two touch points on the touch-sensitive module 102 by two pointing objects according to an exemplary embodiment. The touch-sensitive module 102 may be embodied in a number of different manners forming an appropriate touch-sensitive surface, such as in the form of various touch screens, touchpads or the like. As used herein, then, reference may be made to the touch-sensitive module 102 or a touch-sensitive surface (e.g., touch screen) formed by the touch-sensitive module.

In operation, when a pointing object, such as a user's finger or a stylus is placed on the touch screen, the touch-sensitive module 102 may generate one or more induction signals induced by the pointing object. The generated induction signals may be associated with a change in electrical current, capacitance, acoustic waves, electrostatic field, optical fields or infrared light. The detecting module 104 may detect the induction signals associated with the change induced by one or more pointing objects, such as two pointing objects in one or more directions on the touch screen. In an instance in which two pointing objects are simultaneously applied to the touch screen, the calculating unit 1062 may determine the number of pointing objects applied to the touch screen based on the number of rising waves and/or the number of falling waves of the induction signal. The number determining unit 1064 may output the calculated result to the recording module 108. The calculating unit 1062 may comprise a comparison unit (not shown) to compare values of the detected induction signal with a reference signal to determine at least one of the number of rising waves and the number of falling waves of the detected induction signal.

In one exemplary embodiment, there may be a plurality of pointing objects in contact with the touch screen. The recording module 108 may record moving statuses of each pointing object. The angle determining unit 1102 may determine an angle between a line connecting a start point and an end point, and a reference. The reference may be made herein to axis, directions and orientations including X-axis, Y-axis, vertical, horizontal, diagonal, right and/or left. The direction confirming unit 1104 may determine whether a pointing object moves in a direction parallel to the direction that another pointing object moves. In some embodiment of the present invention, the processing module may further comprise a shift direction determining unit. The shift direction determining unit may determine the direction that the pointing objects move.

As described herein, the touch-sensitive module 102 and the processing unit are implemented in hardware, alone or in combination with software or firmware. Similarly, the detecting module 104, the determination module 106, the recording module 108 may each be implemented in hardware, software or firmware, or some combination of hardware, software and/or firmware. As hardware, the respective components may be embodied in a number of different manners, such as one or more CPUs (Central Processing modules), microprocessors, coprocessors, controllers and/or various other hardware devices including integrated circuits such as ASICs (Application Specification Integrated Circuits), FPGAs (Field Programmable Gate Arrays) or the like. As will be appreciated, the hardware may include or otherwise be configured to communicate with memory, such as volatile memory and/or non-volatile memory, which may store data received or calculated by the hardware, and may also store one or more software or firmware applications, instructions or the like for the hardware to perform functions associated with operation of the device in accordance with exemplary embodiments of the present invention.

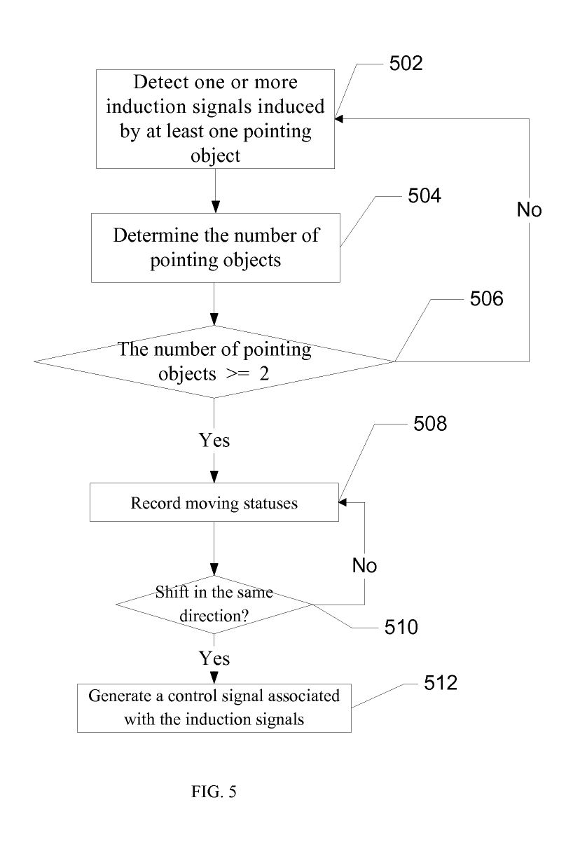

FIG. 5 illustrates various steps in a method of identifying a shifting gesture according to one exemplary embodiment of the present invention. When a pointing object, such as a finger, comes into contact with the touch screen at a touch point, the touch-sensitive module 102 may sense the contact and generate one or more induction signals. The detecting module 104 may detect the induction signals induced by the pointing object at step 502. In an instance in which two or more pointing objects are simultaneously applied to the touch screen, the number of the pointing objects may be obtained by the determination module 106 at step 504. In an instance in which the number of pointing objects is determined to be larger than or equal to two at step 506, the recording module 108 may record movement status of each pointing object at step 508. In some instances in which one pointing object performs a moving operation in the same direction as another pointing object does at step 510, a control signal associated with the detected induction signals are generated by the processing module 110 at step 512. In an instance in which the number of the pointing objects is less than 2, the device of identifying a shifting gesture 100 may await and detect a next induction signal induced by one or more pointing objects at step 502. In an instance in which the gesture applied to the touch screen may not be a shifting gesture at step 510, continue to detect and determine the moving status of the pointing objects at step 508.

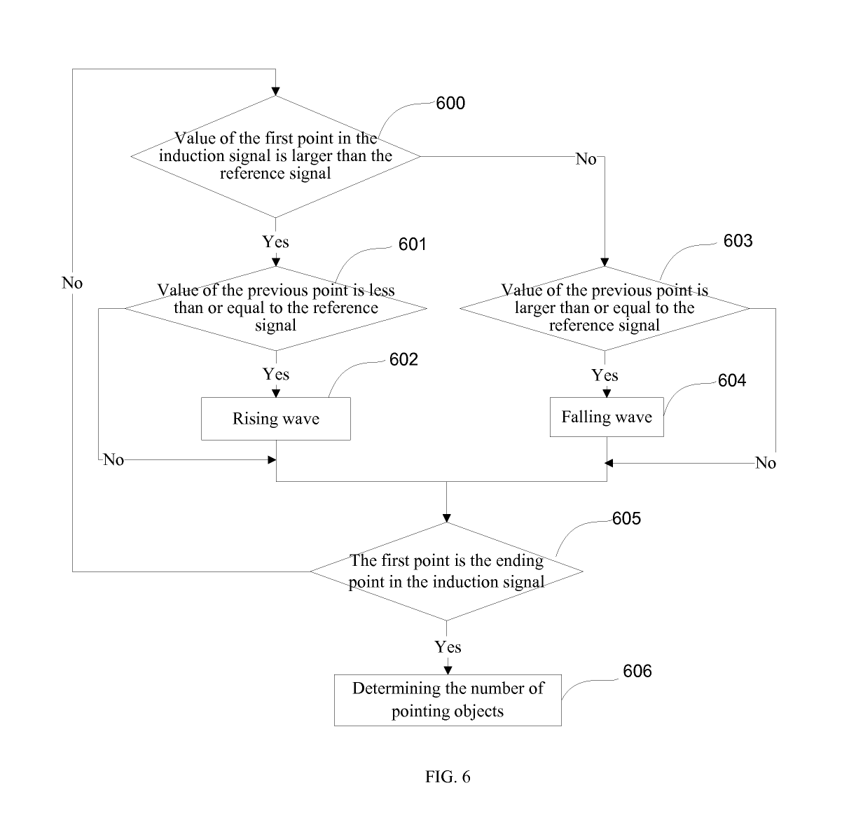

FIG. 6 illustrates a method of determining the number of pointing objects that contact the touch screen according to one exemplary embodiment of the present invention. When at least one pointing object is in contact with the touch screen, an induction signal sensed and generated by the touch-sensitive module 102 may be detected by the detecting module 104.

At step 600, value of a first point of the induction signal is compared to a reference signal by the calculating unit 1062. In an instance in which the value of the first point is larger than the reference signal, value of a previous point of the induction signal is compared to the reference signal by the calculating unit 1062. In an instance in which the value of the previous point is less than or equal to the reference signal at step 601, the wave is determined as a rising wave at step 602. In an instance in which the value of the previous point is larger than or equal to the reference signal, the determination module 106 may determine if the first point is the last point in the induction signal at step 605. If it is determined as the last point, the number of pointing objects may be determined at step 606 based on the number of rising waves and/or the number of falling waves and may be output by the number determining unit 1064 to the recording module 108.

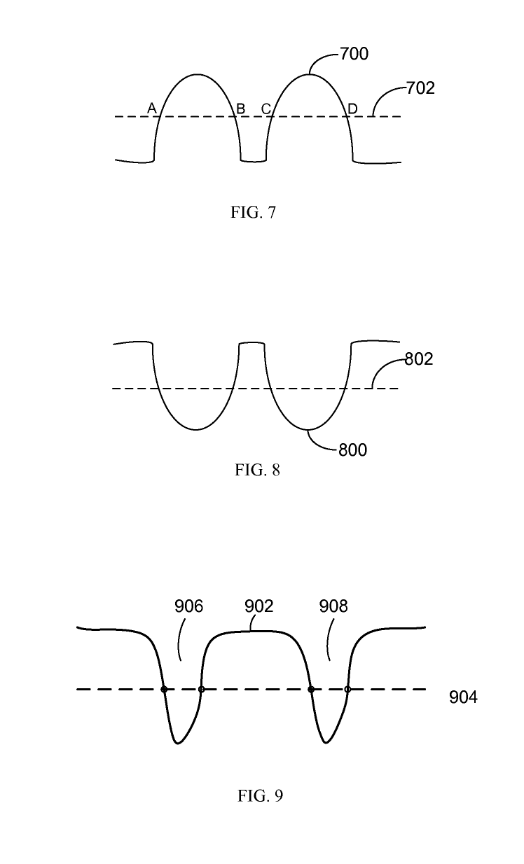

In an instance in which the value of the first point is less than the reference signal at step 600, value of the previous point in the induction signal is compared to the reference signal at step 603. In an instance in which the value of the previous point is larger than or equal to the reference signal, the wave is determined as a falling wave at step 604. The process may proceed to step 605 to determine if the first point is the last point in the induction signal. In an instance in which the first point is not the last point in the induction signal at step 605, the process may otherwise proceed to select a next point and compare value of the next point to the reference signal at step 600. If it is determined as the last point, the number of pointing objects may be determined at step 606 based on the number of rising waves and/or the number of falling waves and may be output by the number determining unit 1064. In an exemplary embodiment, the number of the pointing objects is determined according to the maximum number of rising waves or falling waves of the first induction signal or the second induction signal. In an exemplary embodiment, if the number of the rising waves is not equal to that of the falling waves, the process may await next induction signals. In one exemplary embodiment, a first initial induction value and a second initial induction value may be predetermined. In the exemplary embodiment as illustrated in FIG. 7, the first initial induction value and the second initial induction value are predetermined less than the reference signal. In another exemplary embodiment as illustrated in FIG. 8, the first initial induction value and the second initial induction value are predetermined larger than the reference signal. In this manner, the value of the first point of the detected induction signal may be compared to the predetermined first initial induction signal. The value of the last point of the detected signal may be compared to the predetermined second initial induction signal. In an alternative instance, the value of the first point of the detected induction signal and the predetermined first initial induction value may be compared to the reference signal. The predetermined second initial induction value and the value of the last point of the detected signal may be compared with the reference signal.

FIG. 7 illustrates a diagram of a detected induction signal 700 and a reference signal 702 according to one exemplary embodiment of the present invention. In an instance in which a pointing object comes into contact with the touch screen at a touch point, the contact at that touch point may induce the touch-sensitive module 102 to generate the induction signal 700. Accordingly, the number of rising waves or the number of falling waves may corresponds to the number of pointing objects that are in contact with the touch screen. The rising wave may cross the reference signal at points A and C (referred as “rising point”). The falling wave may cross the reference signal at points B and D (referred as “drop point”). Due to some unexpected noises, the induction signal may not be induced by a valid contact of a pointing object. To determine whether an induction signal induced by a valid contact, the distance between one rising point and a subsequent drop point may be measured and compared to a predetermined threshold value by the comparing unit 1062. If the distance is larger than the predetermined threshold value, the induction signal is determined to be induced by a valid touch. For example, the distance between the rising point A and its subsequent drop point B may be measured and compared to a predetermined threshold value.

Different induction signal waves may be obtained due to different analyzing methods or processing methods. FIG. 8 illustrates an induction signal 800 induced by a contact with the touch screen and a reference signal 802 according to an exemplary embodiment. The method of determining a valid contact at a touch point and the number of touch points may be similar to that is described above. To determine whether an induction signal induced by a valid contact, the distance between one drop point and a subsequent rising point may be measured and compared to a predetermined threshold value by the calculating unit 1062. If the distance is larger than the predetermined threshold value, the induction signal is determined to be induced by a valid touch.

Touch points may be determined by measuring the attenuation of waves, such as ultrasonic waves, across the surface of the touch screen. For instance, the processing unit may send a first electrical signal to a transmitting transducer. The transmitting transducer may convert the first electrical signal into ultrasonic waves and emit the ultrasonic waves to reflectors. The reflectors may refract the ultrasonic waves to a receiving transducer. The receiving transducer may convert the ultrasonic waves into a second electrical signal and send it back to the processing unit. When a pointing object touches the touch screen, a part of the ultrasonic wave may be absorbed causing a touch event that may be detected by the detecting module 104 at that touch point. Coordinates of the touch point are then determined. An attenuated induction signal 902 crossed by a reference signal 904 and two attenuation parts 906 and 908 are illustrated in FIG. 9.

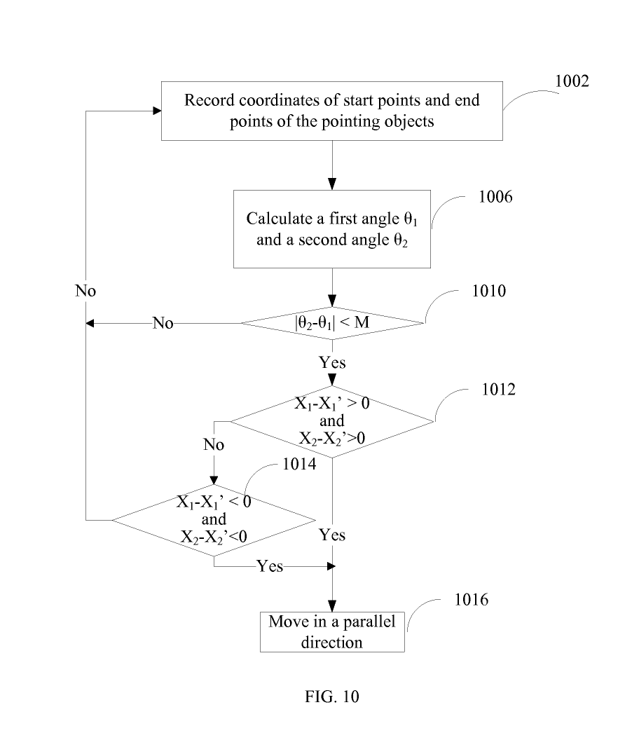

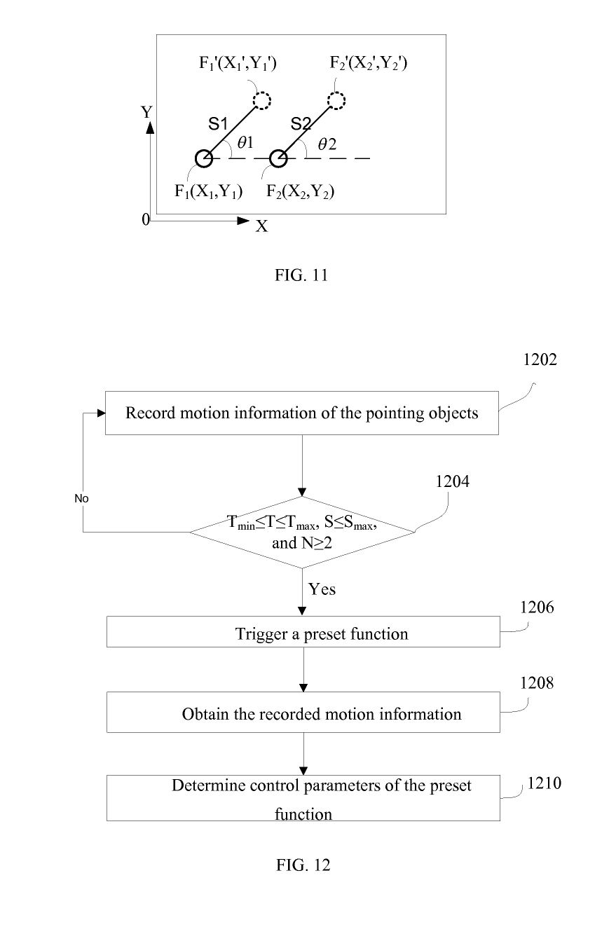

FIG. 10 illustrates a method of identifying a shifting gesture according to one exemplary embodiment of the present invention. There may be a plurality of pointing objects that simultaneously come into contact with the touch screen to perform a gesture, and which pointing objects may induce a plurality of detectable induction signals. With reference to FIG. 11, two pointing objects come into contact with the touch screen at start points F₁′ or F₂′, respectively. Each pointing object may move from its start point (F₁′ or F₂′) to its respective end point. For instance, one pointing object moves from F₁′ to F₁. Another pointing object moves form F₂′ to F₂. To determine whether one pointing object moves in a direction parallel to the direction that another pointing object moves, coordinates (X₁′, Y₁′) of the start point F₁′ and coordinates (X₁, Y₁) of the end point F₁ of a first pointing object may be recorded by the recording module 108 at step 1002. Similarly, coordinates (X₂′, Y₂′) of the start point F₂′ and coordinates (X₂, Y₂) of the end point F₂ of a second pointing object may be recorded by the recording module 108 at step 1002. At step 1006, a first angle θ₁ defined between the line connecting the start point F₁′ to the end point F₁, and X-axis may be obtained by the processing module 110. Similarly, a second angle θ₂ defined between the line connecting the start point F₂′ to the end point F₂, and X-axis may be obtained by the processing module 110 at step 1006.

In an instance in which the absolute value of the difference between the coordinates of the start point F₁′ and the end point F₁ of the first pointing object on X-axis is not greater than a predetermined value L, i.e., |X₁−X₁′|<=L, the first angle θ₁ is obtained depending on the coordinates of the end point F₁ and the start point F₁′ of the first pointing object on Y-axis. In an instance in which the difference between the coordinates of the end point F₁ and the start point F₁′ of the first pointing object on Y-axis is not less than the predetermined value L, i.e., Y₁-Y₁′>=L, the first angle θ₁ is determined as 90°. In an instance in which the difference between the coordinates of the end point F₁ and the start point F₁′ of the first pointing object on Y-axis is not less than a predetermined value −L, i.e., Y₁−Y₁′>=−L, the first angle θ₁ is determined as −90°. In an instance in which the difference between the coordinates of the end point F₁ and the start point F₁′ of the first pointing object on Y-axis is greater than the predetermined value −L and less than the predetermined value L, i.e., −L<Y−Y₁′<L, the first angle θ₁ is obtained through various method, such as function arctan, i.e., θ₁=arctan((Y₁−Y₁′)/(X₁−X₁′)).

Similarly, when the absolute value of the difference between the coordinates of the start point F₂′ and the end point F₂ of the second pointing object on X-axis is not greater than the predetermined value L, i.e., |X₂−X₂′|<=L, the second angle θ₂ is obtained depending on the coordinates of the end point F₂ and the start point F₂′ of the second pointing object on Y-axis. In an instance in which the difference between the coordinates of the end point F₂ and the start point F₂′ of the second pointing object on Y-axis is not less than the predetermined value L, i.e., Y₂−Y₂′>=L, the second angle θ₂ of the second pointing object is determined as 90°. In an instance in which the difference between the coordinates of the end point F₂ and the start point F₂′ of the second pointing object on Y-axis is not less than the predetermined value −L, i.e., Y₂−Y₂′>=−L, the second angle θ₂ of the second pointing object is −90°. In an instance in which the difference between the coordinates of the end point F₂ and the start point F₂′ of the second pointing object on Y-axis is greater than the predetermined value −L and less than the predetermined value L, i.e., −L<Y₂-Y₂′<L, the second angle θ₂ is obtained through various mathematic functions, such as arctan, i.e., θ₂=arctan((Y₂−Y₂′)/(X₂−X₂′)).

In an instance in which the difference between the first angle θ₁ and the second angle θ₂ is determined to be less than a predetermined value M at step 1010, difference between the coordinates of the start point F₁′ and the end point F₁ of the first pointing object on X-axis, i.e., X₁−X₁′ and difference between the coordinates of the start point F₂′ and the end point F₂ of the second pointing object on X-axis, i.e., X₂−X₂′, are compared to zero at step 1012. If both differences are greater than zero (X₁−X₁′>0 and X₂−X₂′>0), it determines that the first pointing object moves in a direction parallel to the direction that the second pointing object moves in at step 1016. In an instance in which at least one of the differences (X₁−X₁′ and/or X₂′ X₂′) is less than zero at step 1012, the method proceeds to step 1014. In an instance in which both differences are less than zero (X₁−X₁′<0 and X₂−X₂′<0) at step 1014, it determines that the first pointing object moves in a direction parallel to the direction that the second pointing object moves in at step 1016. In an instance in which one and only one of the differences is greater than zero at step 1014, i.e., either X₁−X₁′>0 or X₂−X₂′>0, the method proceeds back to step 1002 to record new coordinates of the pointing objects. The predetermined value M, L and −L are capable of being adjusted. The processing module 110 may then generate control signals to execute commands associated with the generated control signals. If the first pointing object moves in a direction parallel to the direction that the second pointing object moves in, the processing module 110 determines that the pointing objects perform a shifting gesture and generate control signal to execute shifting commands.

FIG. 12 illustrates a method of triggering a preset function according to one exemplary embodiment of the present invention. If at least two pointing objects contact the touch-sensitive surface and perform a gesture, the recording module 108 records motion information of the pointing objects at step 1202. Motion information may comprise time interval T during which the user's finger remains in contact with the touch-sensitive surface, displacement S that a pointing object moves from a start point to an end point on the touch-sensitive surface during the time interval T, and the number of the pointing objects, N. In an instance in which the time interval T is greater than a first predetermined time interval value Tₘᵢₙ and less than a second predetermined time interval value Tₘₐₓ(Tₘᵢₙ≦T≦Tₘₐₓ), and the displacement S is not greater than a predetermined displacement value Sₘₐₓ(S≦Sₘₐₓ), and the number of pointing objects are not less than 2(N≧2) at step 1204, a preset function is triggered at step 1206. The preset function may be a paging function or a scrolling function.

Motion information may further comprise moving direction, coordinates of the pointing objects, and an angle θ between the line connecting a start point and an end point of a pointing object, and a reference. The reference may be axes, directions and orientations including X-axis, Y-axis, vertical, horizontal and/or diagonal. The processing module 108 may obtain the recorded motion information at step 1208. Control parameters and setting of the control parameters of the preset function may be determined by the parameter setting module 114 at step 1210 according to the motion information obtained at step 1208. The control parameters may comprise paging direction or scrolling direction according to the angle θ, paging speed or scrolling speed according to the displacement S.

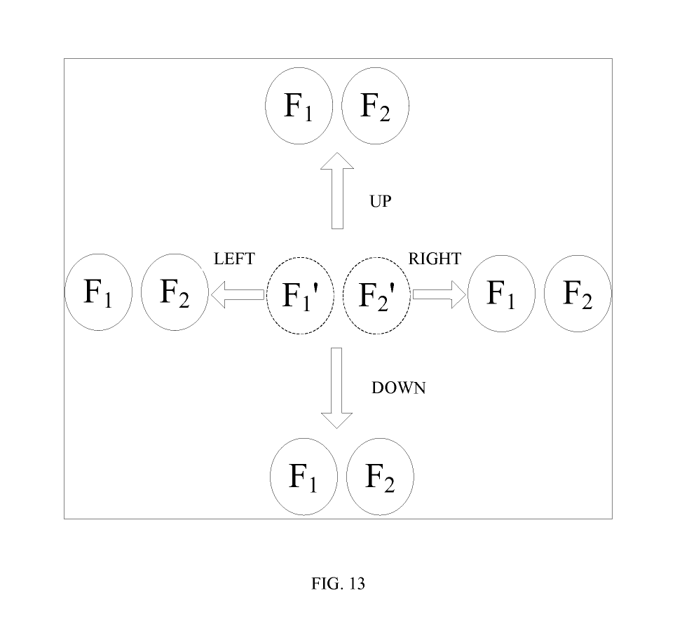

FIG. 13 is a diagram illustrating moving directions of two pointing objects according to exemplary embodiments of the present invention. The pointing objects may move right, left, up or down.

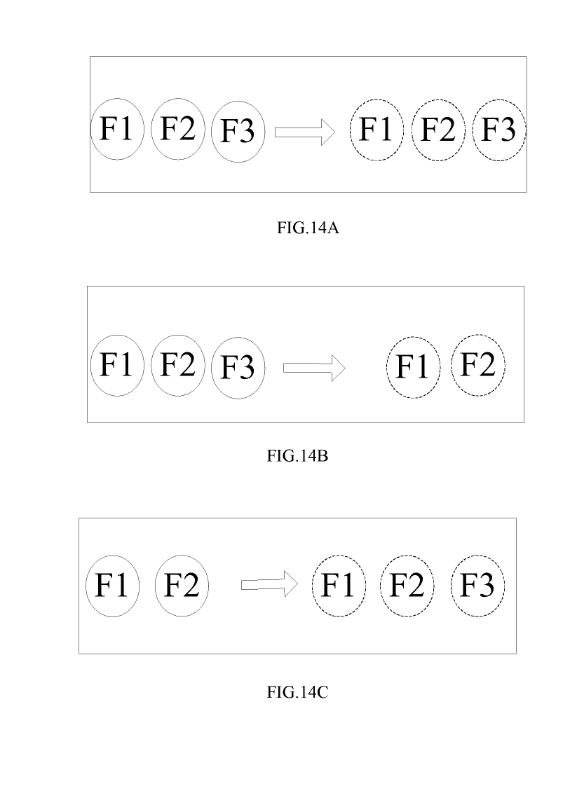

FIGS. 14A-C illustrate moving statuses of the pointing objects on the touch-sensitive surface according to exemplary embodiments of the present invention. When a function is triggered, the number of the pointing objects in contact with the touch-sensitive surface may change. The change may or may not influence the being-executed function. For instance, three pointing objects may rest on the touch-sensitive surface on their respective start points. The number of pointing objects may remain the same during execution of the function as illustrated in FIG. 14A. The number of pointing objects may be reduced as illustrated in FIG. 14B or increased as illustrated in FIG. 14C. The remained pointing objects may move to their respective end points. The processing module 110 will be executing the triggered function.

All or a portion of the system of the present invention, such as all or portions of the aforementioned processing module 110 and/or one or more modules of the device of identifying a shifting gesture 100, may generally operate under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of identifying a shifting gesture comprising:
detecting one or more induction signals induced by one or more pointing objects that come into contact with a touch-sensitive surface;
determining the number of the pointing objects that come into contact with the touch-sensitive surface;
recording moving status and coordinates of each pointing object in an instance in which the number of the pointing objects is larger than a preset number;
determining whether one pointing object moves in a direction parallel to the direction that another pointing object moves in according to the recorded moving status and the coordinates of the pointing objects; and
generating control signals to execute a gesture associated with the determined result.

2. The method of claim 1, wherein determining the number of pointing objects comprises:
selecting a first point and a second point of each detected induction signal, the second point preceding the first point;
comparing values of the two selected points to a reference signal to determine a rising wave or a falling wave; and
determining the number of rising waves and/or falling waves to determine the number of pointing objects.

3. The method of claim 2, wherein comparing values comprises:
comparing a first value of the first point to the reference signal;
comparing a second value of the second point to the reference signal; and
determining a rising wave or a falling wave according to the comparison results.

4. The method of claim 3 further comprising:
identifying one or more rising points on the rising wave intercepted by the reference signal;
identifying one or more drop points on the falling wave intercepted by the reference signal; and
comparing a distance between a rising point and a subsequent drop point to a predetermined threshold value or comparing a distance between a drop point and a subsequent rising point to a predetermined threshold value to determine if the detected induction signal is induced by a valid contact.

5. The method of claim 4, further comprising:
detecting a first induction signal in a first direction; and
detecting a second induction signal in a second direction, wherein the first direction and the second direction have an angle therebetween.

6. The method of claim 4, furthering comprising:
determining the number of the pointing objects according to the number of rising waves or falling waves of the first induction signal or the second induction signal.

7. The method of claim 1, further comprising:
obtaining time interval during which each pointing object remains in contact with the touch-sensitive surface, displacement that each pointing object moves from a start point to an end point on the touch-sensitive surface during the time interval;
triggering a preset function based on the time interval and the displacement of each pointing object; and
determining control parameters of the preset function according to the coordinates of each pointing object.

8. The method of claim 1, further comprising:
determine an angle between a line connecting a start point and an end point of each pointing object and a reference; and
determining if one pointing object moves in a direction parallel to the direction that another pointing object moves according to the angle.

9. A device of identifying a shifting gesture comprising:
a detecting module, configured to detect one or more induction signals induced by one or more pointing objects that come into contact with a touch-sensitive surface;
a determination module, configured to determine the number of pointing objects;
a recording module, configured to record moving status and coordinates of each pointing object if the number of the pointing objects is larger than a preset number; and
a processing module, configured to:
determine if one pointing object moves in a direction parallel to the direction that another pointing object moves according to the moving status and coordinates of each pointing object; and
generate control signals to execute a gesture associated with the determined result.

10. The device of claim 9, wherein the determination module comprises:
a calculating unit, configured to compare values of selected points of the detected induction signal to a reference signal to determine the number of rising waves and the number of falling waves; and
a number determining unit, configured to determine the number of pointing objects that generate the induction signals according to the number of the rising waves and the falling waves.

11. The device of claim 10, wherein the calculating unit further configured to:
select a first point and a second point of each detected induction signal, the second point preceding the first point;
compare values of the two selected points to the reference signal to determine a rising wave or a falling wave; and
determine the number of rising waves and/or falling waves to determine the number of pointing objects.

12. The device of claim 9, further comprising:
a function triggering module, configured to trigger a preset function based on time interval during which each pointing object remains in contact with the touch-sensitive surface, displacement that each pointing object moves from a start point to an end point on the touch-sensitive surface during the time interval; and
a parameter setting module, configured to determine control parameters of the preset function according to the coordinates of each pointing object.

13. The device of claim 9, wherein the processing module comprises:
an angle determining unit, configured to determine an angle between a line connecting a start point and an end point of each pointing object and a reference; and
a direction determining unit, configured to determine if one pointing object moves in a direction parallel to the direction that another pointing object moves according to the angle.

14. The device of claim 9, wherein the detecting module comprises:
a transmitting transducer, configured to receive a first electrical signal from the processing module, convert the received first electrical signal into an acoustic signal and emit the acoustic signal to a reflector; and
a receiving transducer, configured to receive the acoustic signal from the reflector, convert the acoustic signal into a second electrical signal and send the second electrical signal to the processing module.
